(19) United States
(12) Patent Application Publication
(10) Pub. No.: US 2009/0225271 A1
(43) Pub. Date: Sep. 10, 2009

(54) Eyeglasses

(76) Inventors: Ramak Radmard, Lachine (CA); Michael Toulch, Cote St-Luc (CA)

Correspondence Address: Louis Tessier, P.O. Box 54029, Town of Mount-Royal, QC, H3P 3H4, CA

(21) Appl. No.: 12/382,019

(22) Filed: Mar. 6, 2009

Related U.S. Application Data
(60) Provisional application No. 61/064,473, filed on Mar. 7, 2008.

(51) Int. Cl. G02C 1/02

(52) U.S. Cl. 351/140

(57) ABSTRACT

A lens and eyeglasses component assembly, the lens and eyeglasses component assembly comprising: a lens, the lens defining a lens first surface, a substantially opposed lens second surface and a lens peripheral surface extending therebetween, the lens also defining a lens aperture extending between the lens first and second surfaces, the lens aperture being located adjacent the lens peripheral surface and defining a lens gap in the lens peripheral surface leading thereinto, the lens aperture defining a lens aperture peripheral surface; an eyeglasses component, the eyeglasses component defining a lens attachment portion inserted in the lens aperture; and a locking component inserted in the lens aperture, the locking component frictionally engaging both the lens aperture peripheral surface and the lens attachment portion; whereby the locking component attaches the eyeglasses component to the lens.

This application claims priority from U.S. provisional patent application 61/064,473 filed Mar. 7, 2008.

### FIELD OF THE INVENTION

This invention relates generally to the field of eyeglasses.

### BACKGROUND OF THE INVENTION

There is a multitude of eyeglasses models produced. However, despite numerous efforts by many inventors, currently commercialized eyeglasses have many drawbacks.

For example, a type of eyeglasses that is relatively popular is rimless eyeglasses. Instead of having a rim into which lenses are inserted, these eyeglasses include lenses that are attached to each other through a bridge, the bridge including a nose pad. Also, side arms are attached directly to the lenses. However, in this type of eyeglasses, there is a need to prepare the lenses so that these components can be attached thereto. This typically requires the use of specialized tooling and needs to be done carefully with a relatively large precision so that the eyeglasses are aesthetically pleasant, comfortable to wear by the intended user and present suitable optical characteristics.

Furthermore, the bridge and side arms are typically attached using small screws or small nuts and bolts, which are relatively fragile, and which also sometimes require the use of locking glue to prevent the screw/bolt from detaching from the remainder of the eyeglasses. Also, these screws and bolts are relatively small and fragile and therefore require great dexterity from an optician who needs to attach these components to the eyeglasses. In the case in which glue is used, it is typically difficult to remove the components for replacement once they have been attached to a lens. Therefore, in cases in which the intended user needs to change one of the components of the eyeglasses, new lenses typically need to be ordered, which can be relatively expensive and cause a delay during which the intended user is not able to use the eyeglasses.

Furthermore, it often occurs that unintended forces are exerted onto the side arms of the eyeglasses, for example in cases in which an impact occurs while the intended user wears the eyeglasses. To that effect, many models of eyeglasses include side arms that can open outwardly over some range to allow the eyeglasses to deform upon impact. However, to ensure proper comfort of the intended user and stability of the eyeglasses onto the head of the intended user, these eyeglasses require that the side arms do not open too easily, which contradicts the requirements that deformation occurs easily to minimize damages. In addition, these prior art eyeglasses have side arms that are only allowed to open up over a relatively small range of angles.

Against this background, there exists a need in the industry to provide novel eyeglasses.

An object of the present invention is therefore to provide improved eyeglasses.

### SUMMARY OF THE INVENTION

In a broad aspect, the invention provides a lens and eyeglasses component assembly, the lens and eyeglasses component assembly comprising: a lens, the lens defining a lens first surface, a substantially opposed lens second surface and a lens peripheral surface extending therebetween, the lens also defining a lens aperture extending between the lens first and second surfaces, the lens aperture being located adjacent the lens peripheral surface and defining a lens gap in the lens peripheral surface leading thereinto, the lens aperture defining a lens aperture peripheral surface; an eyeglasses component, the eyeglasses component defining a lens attachment portion inserted in the lens aperture; and a locking component inserted in the lens aperture, the locking component frictionally engaging both the lens aperture peripheral surface and the lens attachment portion; whereby the locking component attaches the eyeglasses component to the lens.

For example, the lens and component assembly includes many components such as a bridge element including a nose pad interconnecting two lenses and two side arms attached each to a respective one of the lenses through a connector.

In some embodiments of the invention, the locking component defines a groove into which glue is insertable to secure the locking component, and consequently the eyeglasses component, to the lens. However, in alternative embodiments of the invention, no glue is used for locking the lens and the locking component to each other.

Advantageously, the proposed lens and component assembly is relatively easily assembled and allows for the replacement of the component attached to the lens with minimal damages to the lens.

In some embodiments of the invention, the eyeglasses include side arms that are operable between a closed, an opened and a released configuration. In the closed configuration, the side arms are substantially adjacent and substantially parallel to the lenses. In this configuration, the eyeglasses can be carried by the intended user in a relatively compact configuration. In the opened configuration, the side arms extend substantially perpendicular to the lenses. In this configuration, the eyeglasses can be worn by the intended user in a conventional manner. In the released configuration, the side arms are located opposite to the lenses relatively to the connector and extend at an angle larger than 90 degrees relatively to the lenses. This configuration is achieved, for example, when an impact or any other forces tending to open the side arms to a larger extent than the opened configuration are exerted onto the eyeglasses.

In some embodiments of the invention, the side arms are movable to an extended configuration occurring between the opened and released configurations. In the extended configuration, the side arms are biased against further opening of the side arms by a biasing element. As the side arms are opened further away from the closed position that the opened configuration, the biasing element biases the side arms toward the opened configuration until a predetermined angle between the lenses and the side arms has been achieved. The predetermined angle is typically achieved when a predetermined force is applied to the side arm. After this predetermined angle has been achieved, the biasing component no longer biases the side arms and the side arms are free to rotate in the released configuration.

Advantageously, the proposed side arms are relatively comfortable to the intended user and allow for adjustment of the eyeglasses to heads having slightly different dimensions without causing undue discomfort to the intended user. For example, the side arms do not exert undue pressure on the temples of the intended user when worn. The side arms also allows for small movements of the eyeglasses relatively to the head of the intended user without causing any damages to the eyeglasses and simultaneously exert a biasing force tending to centre the eyeglasses on the head of the intended user. When the side arms are moved at a position further away from the lenses than the predetermined angle, the side arms are free to rotate away from the lenses, thereby preventing or, at least, reducing the risk of damaging the eyeglasses when relatively large forces are exerted onto the side arms, as well as increasing the safety of the eyeglasses.

In some embodiments of the invention, the connector connecting the side arms to the eyeglasses is composite and includes a body made out of a polymer over which a metal strip is wrapped. This composite nature allows for manufacturing a relatively small and light connector at relatively low costs, while increasing the sturdiness of the connector through the use of the metal strip. Also, in some embodiments of the invention, the metal strip is used to provide a highlight onto the eyeglasses which enhances the aesthetics of the eyeglasses. Furthermore, in some embodiments of the invention, the metal strip also serves to retain the side arm attached to the connector in the released configuration.

While the present document is mainly concerned with rimless eyeglasses, many of the concepts described herein are also applicable to rimmed eyeglasses.

Other objects, advantages and features of the present invention will become more apparent upon reading of the following non-restrictive description of preferred embodiments thereof, given by way of example only with reference to the accompanying drawings.

### BRIEF DESCRIPTION OF THE DRAWINGS

In the appended drawings:

FIG. 1, in a perspective view, illustrate eyeglasses in accordance with an embodiment of the present invention;

FIG. 2, in a partial alternative perspective view, illustrates the eyeglasses shown in FIG. 1;

FIG. 3, in a cross-sectional view taken along the line III-III of FIG. 2, illustrates the eyeglasses shown in FIGS. 1 and 2;

FIG. 3′, in an alternative cross-sectional view taken along the line III′-III′ of FIG. 2, illustrates the eyeglasses shown in FIGS. 1 to 3;

FIG. 4, in a perspective view, illustrates a locking component part of the eyeglasses shown in FIGS. 1 to 3;

FIG. 4′, in an alternative perspective view, illustrates the locking component shown in FIG. 4;

FIG. 5, in a top elevation view, illustrates a connector body of a connector part of the eyeglasses shown in FIGS. 1 to 3;

FIG. 6, in a perspective exploded view, illustrates a connector part of the eyeglasses shown in FIGS. 1 to 3;

FIG. 7, in a perspective view, illustrates a step in the assembly of a side arm part of the eyeglasses shown in FIGS. 1 to 3 with the connector shown in FIG. 6;

FIG. 8A, in a top plan view, illustrates the connector shown in FIG. 6;

FIG. 8B, in a side cross-sectional view along the line VIIIB-VIIIB of FIG. 8A, illustrates the connector shown in FIGS. 6 and 8A;

FIG. 8C, in a side elevation view, illustrates the connector shown in FIGS. 6, 8A and 8B;

FIG. 8D, in a side cross-sectional view along the line VIIID-VIIID of FIG. 8C, illustrates the connector shown in FIGS. 6 and 8A-8C;

FIG. 8E, in a side cross-sectional view along the line VIIIE-VIIIE of FIG. 8A, illustrates the connector shown in FIGS. 6 and 8A-8D;

FIG. 9, in a perspective view, illustrates another step in the assembly of the side arm part shown in FIG. 7 with the connector shown in FIG. 6;

FIG. 10, in a perspective view, illustrates another step in the assembly of the side arm part shown in FIG. 7 with the connector shown in FIG. 6;

FIGS. 11A to 11C, in partial perspective views, illustrate successive steps in the attachment of the connector shown in FIGS. 6-10 to the lenses of the eyeglasses shown in FIGS. 1 and 2; and

FIGS. 12A to 12D, in partial perspective views, illustrate alternative configurations of side arms part of the eyeglasses shown in FIGS. 1 and 2 relatively to the lenses of the eyeglasses shown in the same Figs.

### DETAILED DESCRIPTION

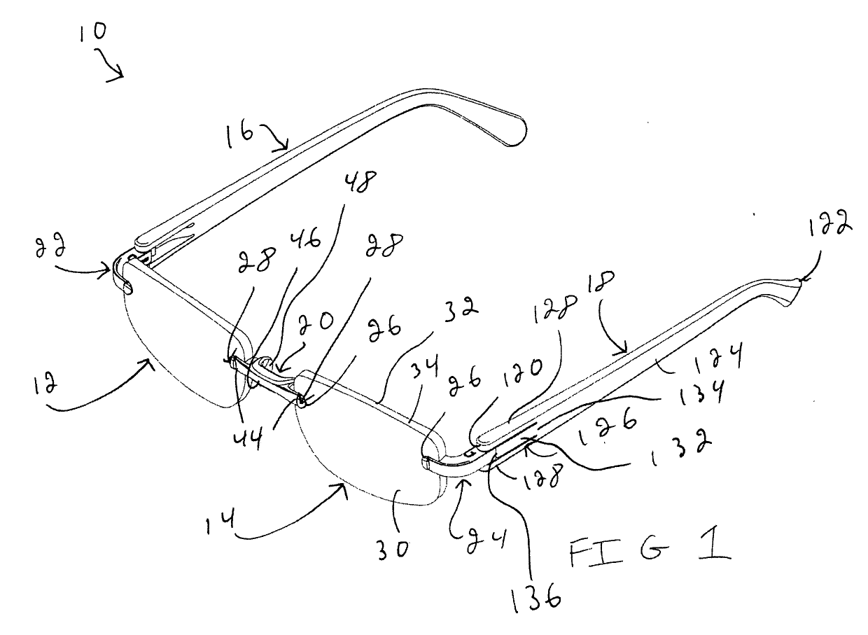

Referring to FIG. 1, there is shown a pair of eyeglasses 10. The eyeglasses 10 include two lenses 12 and 14 disposed in a side by side relationship relatively to each other. Side arms 16 and 18 are each connected respectively to one of the lenses 12 and 14 and located substantially opposed to each other relatively to the lenses 12 and 14. A bridge element 20 extends between the lenses 12 and 14. The side arms 16 and 18 are attached respectively to the lenses 12 and 14 by a respective connector 22 and 24. The side arms 16 and 18, along with the bridge element 20, are eyeglasses components that are attachable to the lenses 12 and 14.

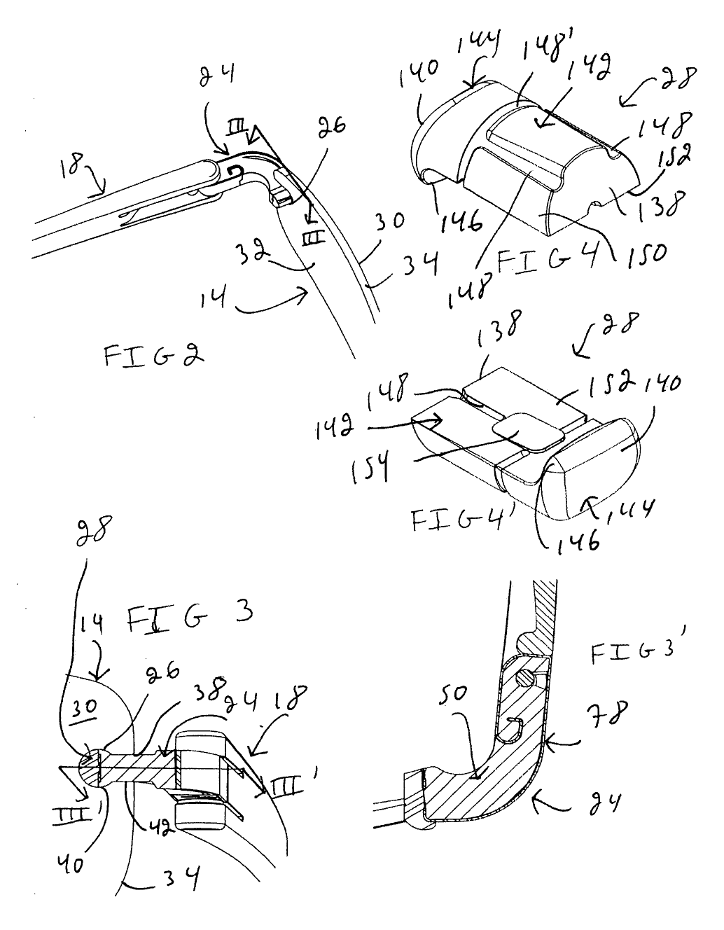

Referring to FIG. 2, the attachment between the lens 14 and the connector 24 is illustrated in greater details. The lens 12 is attached to the connector 22 in a similar manner and this attachment is therefore not described in further details herein. The lens 14 defines a lens first surface 30 and a lens second surface 32. The lens second surface 32 is substantially opposed to the lens first surface 30 and a lens peripheral surface 34 extends between the lens first and second surfaces 30 and 32. As seen in FIG. 1, the lens 14 defines two substantially opposed lens apertures 26, each extending between the lens first and second surfaces 30 and 32. The lens apertures 26 are substantially diametrically opposed to each other and are usable for attaching the bridge element 20 and the connectors 22 and 24 to the lenses 12 and 14, as described in further details hereinbelow. As better seen in FIG. 3, each of the lens apertures 26 is located adjacent the lens peripheral surface 34 and defines a lens gap 38 in the lens peripheral surface 34. The lens gap 38 leads into the lens aperture 26.

Each of the lens apertures 26 defines an aperture inner portion 40 and an aperture outer portion 42. The aperture outer portion 42 is located closer to the lens peripheral surface 34 than the aperture inner portion 40. The aperture inner portion 40 extends from the aperture outer portion 42 and the aperture outer portion 42 extends from the lens gap 38. Typically, the aperture outer portion 42 has a substantially rectilinear and parallelepiped-shaped configuration, while the aperture inner portion 40 has a substantially cylindrical configuration. However, other configurations of the aperture inner and outer portions 40 and 42 are within the scope of the invention. Typically, the aperture inner portion 40 has a diameter that is larger than the width of the lens gap 38.

Generally speaking, each of the components that are attachable to the lenses 12 and 14, such as the connectors 22 and 24 and the bridge element 20, defines a lens attachment portion insertable into the lens aperture 26. A locking component 28 is also inserted also in the lens aperture 26. The locking component 28 frictionally engages both the lens aperture peripheral surface 36 and the lens attachment portion of the component inserted into the lens aperture 26. The locking component 28 attaches the eyeglasses components to the lenses 12 and 14. Also, in some embodiments of the invention, the locking component 28 mechanically engages the lens attachment portion to provide an interference between these two components and enhance the locking action of the locking component.

More specifically, as seen in FIG. 1, the bridge element 20 includes two substantially opposed bridge lens attachment 44, a bridge body 46 extending between the bridge lens attachments 44 and a nose pad 48 extending from the bridge body 46. The bridge body 46 and the nose pad 48 are conventional and will therefore not be described in further details. The bridge lens attachment 44 is similar in shape and function to a connector lens attachment 72 that is described in further details hereinbelow. Therefore, the bridge lens attachment 44 will also not be described in further details.

FIGS. 5, 6, 7 and 8A-8E illustrate in greater details the connector 24. The connector 22 is similar to the connector 24 and is therefore not described in further details. The connector 24 includes a generally L-shaped connector body 50 defining a connector top surface 60, a substantially opposed connector bottom surface 62, a connector outer surface 66 extending between the connector top and bottom surfaces 60 and 62, a connector inner surface 64 extending also between the connector bottom and top surfaces 60 and 62 and two substantially opposed connector first and second end surfaces 68 and 70 also each extending between the connector top and bottom surfaces 60 and 62. The connector outer surface 66, inner surface 66, first end surface 68 and second end surface 70 together form a connector peripheral surface 61 extending between the connector top and bottom surfaces 60 and 62. The connector inner and outer surfaces 64 and 66 are substantially opposed to each other and each extend between the connector first and second end surfaces 68 and 70.

The connector outer surface 66 face laterally outwardly relatively to the lenses 12 and 14 when the eyeglasses 10 are assembled. The connector inner surface 64 face laterally inwardly relatively to the lenses 12 and 14 when the eyeglasses 10 are assembled. Therefore, the connector inner surfaces 64 of connectors 22 and 24 face each other when the eyeglasses 10 are assembled. The connector first end surface 68 is located in the lens aperture 26 when the eyeglasses 10 are assembled.

The reader skilled in the art will readily appreciate that directional terminology such as top, bottom and lateral, for example, is used in this document to facilitate the description of the eyeglasses 10 and refer to orientations relative to the eyeglasses 10 when the eyeglasses 10 are worn in a conventional manner by an upstanding intended user (not shown in the drawings). However, the use of this directional terminology should not be used to restrict the scope of the present invention and this terminology is used only to facilitate the description.

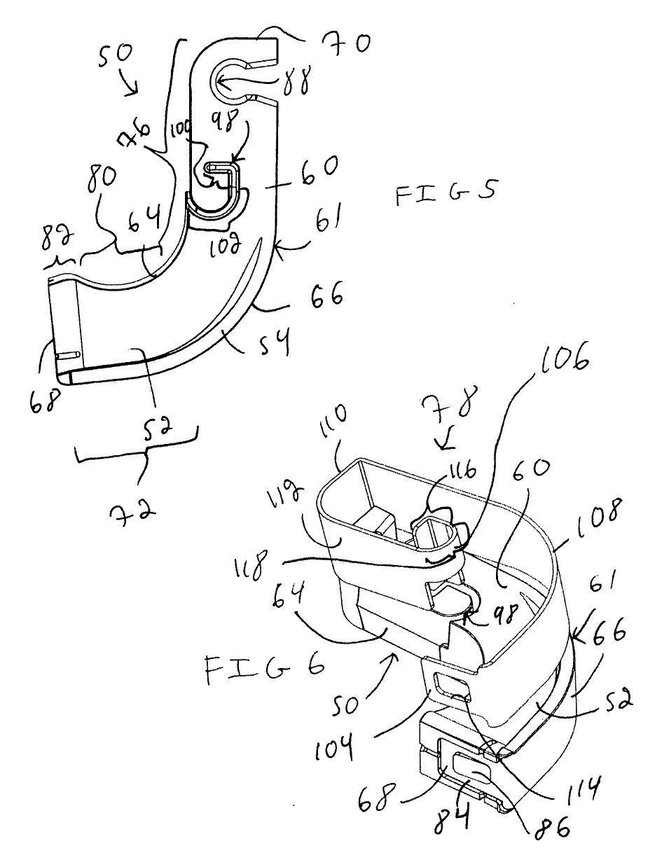

Referring to FIG. 5. the connector body 50 defines a connector lens attachment 72 for attaching the connector 24 to the lens 12, a connector side arm attachment 74 for attaching one of the side arms 16 and 18 thereto and a connector base 76 extending therebetween. Furthermore, in some embodiments of the invention, the connector 22 includes a strip 78, seen for example in FIG. 6, which is releasably attachable to the remainder of the connector body 50 and is positionable over at least a portion of the connector peripheral surface 61. The strip 78 and its function will be described in further details hereinbelow.

As seen for example in FIGS. 5 and 6, the connector top surface 60 defines a top surface recess 52 extending into the connector body 50 at a location intermediate the connector first and second end surfaces 68 and 70. The top surface recess 52 has a portion thereof in the connector lens attachment 72. The connector outer surface 66 defines a flange 54 protruding upwardly from the top surface recess 52. In register with the top surface recess 52, the connector inner surface 64 extends over a smaller extent between the connector top and bottom surfaces 60 and 62 than the connector outer surface 66.

The connector lens attachment 72 includes a lens attachment proximal portion 80 and a lens attachment distal portion 82. The connector first end surface 68 is defined by the lens attachment distal portion 82. The lens attachment distal portion 82 is typically insertable into the aperture inner portion 40, while the aperture outer portion 42 receives the lens attachment proximal portion 80. The lens attachment distal portion 82 therefore extends from the lens attachment proximal portion 80, which itself extends from the connector base 76. A distance between the connector top and bottom surfaces 60 and 62 is typically larger in the lens attachment distal portion 82 than in the lens attachment proximal portion 80. The lens attachment proximal portion 80 is dimensioned so as to be substantially fittingly received within the aperture outer portion 42. Therefore, the lens attachment distal portion 82, by having dimensions larger than the lens attachment proximal portion 80, substantially prevents motions of the connector 24 in a lateral direction relatively to the lens 24.

As better seen in FIG. 7, the connector lens attachment 72 also defines, in the connector first end surface 68, a first end surface recess 84 and a first end surface protrusion 86 extending inside the first end surface recess 84. Typically, the first end surface recess 84 has a substantially U-shaped configuration opening toward the connector outer surface 66. The first end surface protrusion 86 is substantially wedge shaped and tapers in a direction leading toward the connector outer surface 66.

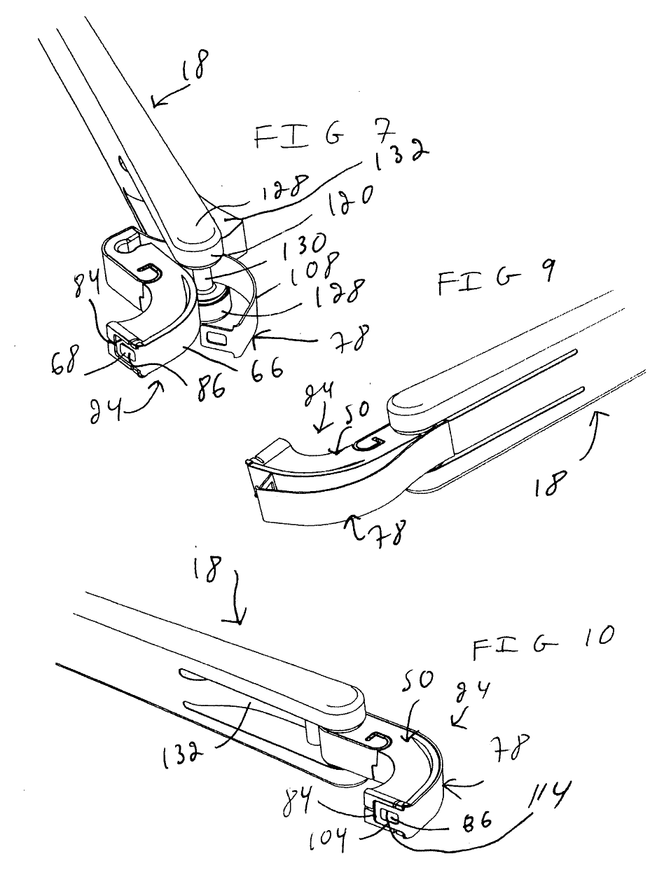

Referring to FIG. 8A, the connector side arm attachment 74 defines a side arm attachment recess 88 extending between the connector top and bottom surfaces 60 and 62. The side arm attachment recess 88 defines an attachment recess inner section 92 and an attachment recess outer section 94 extending therefrom. The attachment recess outer section 94 extends into the connector side arm attachment 74 from the connector outer surface 66. Typically, the side arm attachment recess 88 has a cross-sectional configuration that is substantially key-hole shaped and extends with a substantially uniform cross-section between the connector top and bottom surfaces 60 and 62. The attachment recess outer section 94 defines an attachment recess side aperture 96 leading thereinto from the connector outer surface 66. The side arm attachment recess 88 receives a portion of the side arm 18, typically a pin that is described in further details hereinbelow. The attachment recess inner section 92 is typically substantially cylindrical and the attachment recess outer section 94 is typically substantially frusto-prismoidal and tapers in a direction leading toward the attachment recess inner section 92.

Referring to FIG. 5, the connector 24 also defines a strip receiving groove 98 for receiving a portion of the strip 78 thereinto so as to lock the strip 78 to the connector 22. The strip receiving groove 98 is located at a location intermediate the side arm attachment recess 88 and the connector lens attachment 72. The strip receiving groove 98 extends toward the connector bottom surface 62 from the connector top surface 60. The strip receiving groove 98 defines a strip receiving groove first section 100 and a strip receiving groove second section 102. The strip receiving groove second section 102 extends from the connector inner surface 64 and the strip receiving groove first section 100 extends from the strip receiving groove second section 102. The strip receiving groove second section 102 is substantially arc-segment-shaped and the strip receiving groove first section 100 is substantially L-shaped. The strip receiving groove 98 forms a substantially closed shape and, therefore, prevents movements of the strip 78 relatively to the connector 22 in the plane defined by the connector top surface 60.

The strip 78 is shaped so as to conform to the shape of the connector peripheral surface 61 over the connector first end surface 68, the connector outer surface 66, the connector second end surface 70 and part of the connector inner surface 64. To that effect, as seen for example in FIG. 6, the strip 78 defines a strip first end segment 104 and a substantially opposed strip second end segment 106. A strip first intermediate segment 108 extends from the strip first end segment 104. A strip second intermediate segment 110 extends from the strip first intermediate segment 108 and a strip third intermediate segment 112 extends from the strip second intermediate segment 110. The strip second end segment 106 extends from the strip third intermediate segment 112.

As seen in FIG. 8D, the strip first end segment 104 is substantially planar and defines a strip first end segment aperture 114 extending therethrough. When the strip 78 is attached to the connector 22, the strip first end segment 104 is received inside the first end surface recess 84 and the first end surface protrusion 86 extends through the strip first end segment aperture 114. The strip first intermediate segment 108 abuts against and substantially entirely covers the connector outer surface 66. The strip second intermediate segment 110 covers the connector second end surface 70 and the strip third intermediate segment 112 covers a portion of the connector inner surface 64. The strip second end segment 106 is received inside the strip receiving groove 98.

The strip second end segment 106 includes a second end segment first section 116 and a second end segment second section 118. The second end segment second section 118 is received inside the strip receiving groove second section 102, and therefore extends from the strip third intermediate segment 112 and the second end segment first section 116 extends from the second end segment second section 118 and is therefore received by the strip receiving groove first section 100. Therefore, the second end segment first section 116 is substantially L-shaped and the second end segment second section 118 is substantially U-shaped so as to be easily received inside the strip receiving groove 98.

In some embodiments of the invention, the second end segment second section 118 has a width substantially smaller than the width of the remainder of the strip 78 and the strip receiving groove first section 100 extends away from the connector top surface 60 to a lesser extent than the strip receiving groove second section 102. This configuration of the strip receiving groove 98 and of the strip 78 guides the positioning of the strip 78 relatively to the connector 22. Also, typically, the strip 78 is dimensioned such that no portion of the strip 78 protrudes from the connector 22 relatively to the connector top and bottom surfaces 60 and 62.

Typically, the connector body 50 is made out of a polymer, which allows for manufacturing a relatively light piece using polymer manufacturing technologies that facilitate the production of this relatively complex component. The strip 78 is typically made out of a metal to bring ruggedness to the connector 24, for example by using the relatively high tensile strength of such materials, and to also be relatively easily manufacturable using sheet metal manufacturing technologies.

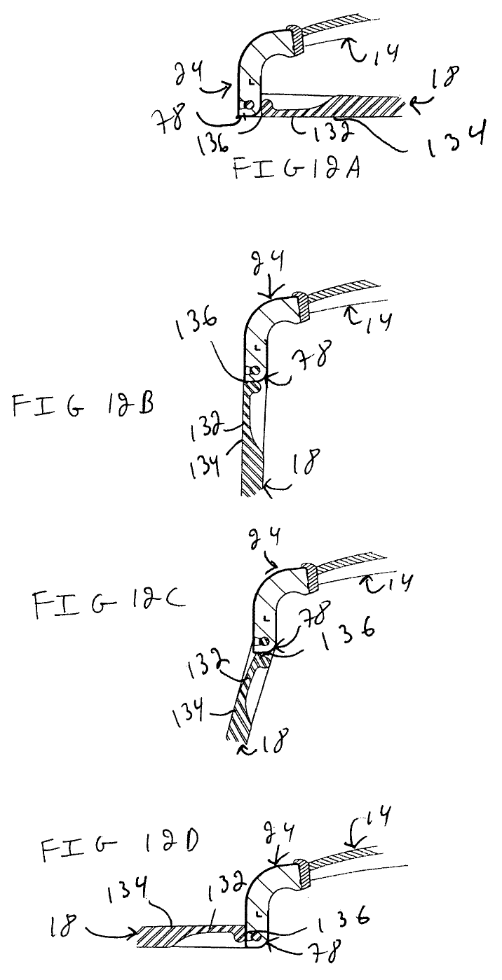

The side arms 16 and 18 are described with reference to the side arm 18. The side arm 16 is substantially similar to the side arm 18. As seen for example in FIGS. 12A to 12D, the side arm 18 defines a side arm proximal end 120 that is located substantially adjacent the connector 24 when the side arm 16 is attached to the connector 24 and a substantially opposed side arm distal end 122. A side arm body 124 extends from the side arm distal end 122 toward the side arm proximal end 120. A side arm fork 126 extends from the side arm body 124 toward the side arm proximal end 120. The side arm fork 126 defines two substantially parallel and substantially spaced apart fork legs 128. Typically, the fork legs 128 are spaced apart in a vertical direction and extend substantially longitudinally. A side arm pin 130, seen for example in FIG. 7, extends between the fork legs 128 substantially adjacent the side arm proximal end 120. The side arm pin 130 typically has a substantially cylindrical configuration.

In some embodiments of the invention, a side arm tongue 132 extends between the fork legs 128 from the side arm body 124. The side arm tongue 132 defines a tongue first end 134 located substantially adjacent the side arm body 124 and a tongue second end 136 located substantially opposed to the tongue first end 134. The tongue second end 136 is typically substantially spaced apart from the side arm pin 130.

The side arm tongue 132 is deformable between a tongue released and a tongue compressed configuration. In the tongue released configuration, seen for example in FIG. 12B, the side arm tongue 132 extends substantially rectilinearly. In the tongue compressed configuration, seen for example in FIG. 12C, the side arm tongue 132 is deformed relatively to the configuration of the side arm tongue 132 in the tongue released configuration and the tongue second end 136 is closer to the side arm body 124 than in the tongue released configuration. For example, the side arm tongue 132 has in this configuration a generally arcuate configuration. When the side arm tongue 132 is in the compressed configuration, the side arm tongue biases the tongue second end 136 toward the position achieved by the tongue second end 136 in the released configuration. The side arm tongue 132 forms a biasing element for biasing the side arm 18 toward a side arm opened configuration described in further details hereinbelow.

As seen in FIGS. 12A-12D, the eyeglasses 10 include side arms 16 and 18, only one of which is shown in FIGS. 12A-12D, that are operable between a closed, an opened, an extended and a released configuration. In the closed configuration, as seen in FIG. 12A, the side arms 16 and 18 are substantially adjacent and substantially parallel to the lenses 12 and 14. In this configuration, the eyeglasses 10 can be carried by the intended user in a relatively compact configuration. In the opened configuration, seen in FIG. 12B, the side arms 16 and 18 extend substantially perpendicular to the lenses 12 and 14. In this configuration, the eyeglasses 10 can be worn by the intended user in a conventional manner. In some embodiments of the invention, the side arm tongue 132 frictionally engages the connector 24 when the side arm 18 is moved between the closed and opened configurations. In these embodiments, the connector peripheral surface 61 is substantially arcuate along the path followed by the side arm tongue 132 against the connector peripheral surface 61.

In the released configuration, seen in FIG. 12D, the side arms are located opposite to the lenses 12 and 14 relatively to the connectors 22 and 24 and extend at an angle larger than 90 degrees relatively to the lenses 12 and 14. This configuration is achieved, for example, when an impact or any other forces tending to open the side arms 16 and 18 to a larger extent than the opened configuration are exerted onto the eyeglasses 10. In some embodiments of the invention, the angle between the side arms 16 and 18 and the lenses 12 and 14 can reach a value larger than 180 degrees.

In the extended configuration, as seen in FIG. 12C, the side arms are biased against further opening of the side arms by the side arm tongue 132. The side arm tongue 132 biases the side arms 16 and 18 toward the opened configuration by abutting against the connector 24 and being deformed until a predetermined angle between the lenses 12 and 14 and the side arms 16 and 18 has been achieved. The side arm tongue therefore acts as a leaf spring. The side arms 16 and 18 are therefore in the extended configuration when the side arms 16 and 18 are at an angle relatively to the lenses 12 and 14 comprised between the angle corresponding to the opened position and the predetermined angle. After this predetermined angle has been achieved, the side arm tongue 132 no longer biases the side arms 16 and 18 and the side arms 16 and 18 are free to rotate toward the released configuration. The transition toward this later configuration proceeds through a snapping action of the side arm tongue 132.

As seen in FIG. 4, the locking component 28 defines a locking component first end 138 and a substantially longitudinally opposed locking component second end 140. The locking component 28 defines a locking component body 142 extending from the locking component first end 138. A locking component head 144 extends from the locking component body 142 toward the locking component second end 140. The locking component head 144 defines a locking component flange 146 extending substantially radially outwardly further away than the locking component body 142. Also, the locking component 28 defines locking component grooves 148 extending substantially longitudinally along the locking component body 142. The locking component grooves 148 extend from the locking component first end 138 toward the locking component second end 140 and are interrupted at a location substantially spaced apart from the locking component head 144.

In some embodiments of the invention, the locking component grooves 148 are interlinked by a circumferential groove 148′ located substantially adjacent to the locking component head 144. Also, the locking component body 142 has a substantially hemicylindrical configuration and defines an arcuate surface 150 and a planar surface 152 extending therefrom. The planar surface 152 defines a locking component protrusion 154 having a substantially wedge shape tapering toward the locking component first end 138. The locking component protrusion 154 and the first end surface protrusion 86 together form a substantially parallelepipedic shape when the eyeglasses 10 are assembled and engage each other to snap inside the first end surface recess 84 to lock the connector 24 to the lens 14.

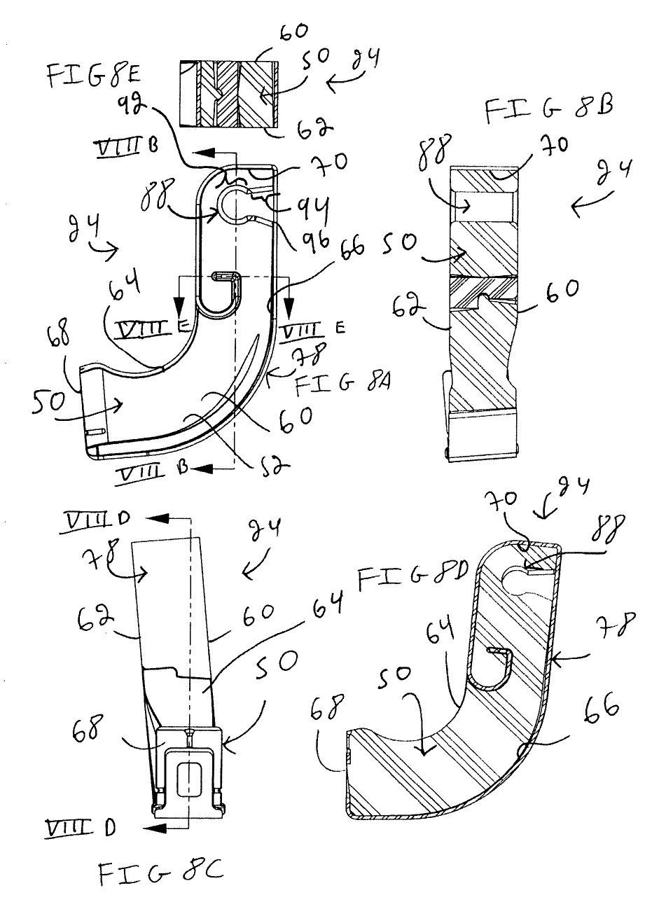

In use, the eyeglasses 10 are assembled as follows with reference to FIGS. 6-10. First, referring to FIGS. 6 and 7, the strip 78 is mounted to the connector body 50. To that effect, the strip second end segment 106 is inserted inside the strip receiving groove 98 and the strip 78 is partially wrapped around the connector peripheral surface 61. More specifically, the strip third intermediate segment 112 is positioned so as to abut against the connector inner surface 64 and the strip second intermediate segment 110 is positioned so as to abut against the connector second end surface 70. Then, as seen in FIG. 7, the strip first intermediate segment 108 is spaced apart from the connector outer surface 66 so as to allow the insertion of the side arm pin 130 therebetween. The side arm pin 130 is then inserted inside the side arm attachment recess 88. The tapered configuration of the attachment recess outer section 94 guides the side arm pin 130 toward the attachment recess inner section 92. Typically, the attachment recess inner and outer sections 92 and 94 are dimensioned such that the side arm pin 130 snaps in place inside the attachment recess inner section 92 where it is substantially free to rotate.

Afterwards, as seen in FIG. 10, the strip 78 is positioned such that the strip first intermediate segment 108 abuts against the connector outer surface 66 and the strip first end segment 104 is received within the first end surface recess 84 with the first end surface protrusion 86 protruding through the strip first end segment aperture 114. Typically, the strip first, second and third intermediate segments 108, 110 and 112 are dimensioned such that, in this position, the strip 78 is relatively firmly attached to the connector 24. The reader skilled in the art will readily appreciate that, in this position, the strip 78 locks the attachment recess side aperture 96, thereby preventing the side arm 18 from being removed from the connector 24.

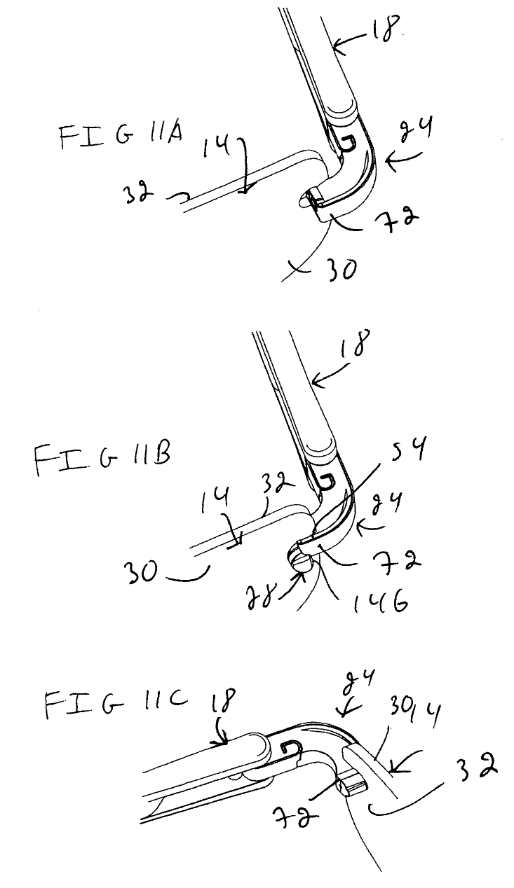

Then, with reference to FIGS. 11A-11C, the connector 24 and all the other components of the eyeglasses 10 that are attachable to the lenses 12 and 14 can be attached to the lens 14 by inserting the connector lens attachment 72 inside the lens aperture 26 in a movement leading from the lens first surface 30 toward the lens second surface 32, as seen in FIG. 11A. Once the connector 24 has been suitably positioned relatively to the lens 12, the locking component 28 is also inserted inside the lens aperture 26, as seen in FIG. 11B. Typically, the locking component 28 is inserted from the lens first surface 30 toward the lens second surface 32. The locking component 28 and the connector 24 are inserted in the lens 14 until the flange 54 and the locking component flange 146 abut against the lens first surface 30. Then, glue is inserted into the locking component grooves 148. The glue fills out the locking component grooves 148 through capillarity.

If relatively weak glue has been used, removal of the connector 24 from the lens 14 is relatively easily performed by pushing on the locking component 28. In other embodiments, the locking component 28 is relatively firmly glued to the lens 14. In these embodiments, the locking component 28 can be simply destroyed, for example using a drill bit or by cutting off the locking component head 144, to allow removal of the connector 24 from the lens 14. Since the locking component 28 is relatively small and relatively easily manufacturable, this component can be considered disposable. In both case, removal of the connector 24 from the lens 14 is performed without incurring unnecessarily large costs to the intended user of the eyeglasses as the lens and the connector are not damaged by this action.

After the eyeglasses 10 have been assembled, the intended user of the eyeglasses 10 can move the side arms 16 and 18 from the closed configuration to the opened configuration. Then, the intended user may position the eyeglasses 10 in a conventional manner onto his face. If relatively small forces are exerted onto the side arms 16 and 18, pushing them away from the lenses 12 and 14, the side arm tongue 132 deforms toward the compressed configuration and, therefore, biases the side arms 16 and 18 toward the opened configuration. This deformation is caused as the tongue second end 136 slides on the strip second intermediate segment 110. This deformation occurs because the centre of rotation of the side arms 16 and 18, which is located in the middle of the side arm attachment recess 88, is eccentric relatively to the centre of curvature of the strip second intermediate segment 110. Relatively small forces exerted onto the side arms 16 and 18 result in relatively easily reversible movements of the side arms 16 and 18 relatively to the lenses 12 and 14. Also, in some embodiments of the invention, the side arms 16 and 18 are similarly biased toward the open configuration in response to relatively small forces directed toward the closed configuration.

If the position of the side arms 16 and 18 reaches a predetermined angle or, alternatively, if a predetermined force is exerted onto the side arms 16 in a direction such that the side arms 16 and 18 are pushed away from the lenses 12 and 14, the side arms 16 and 18 will reach a position at which the side arm tongues 132 no longer abut against the strip second intermediate segment 110. In this position, the side arm tongue 132 deforms back to the uncompressed configuration and the side arms 16 and 18 are freely rotatable relatively to the connectors 22 and 24. Because of the strip 78, the side arms 16 and 18 cannot be removed from the connectors 22 and 24 and the side arms 16 and 18 will therefore only pivot freely without detaching, which may prevent damaging the eyeglasses 10. To get the side arms 16 and 18 back to the opened configuration, the intended user can simply move the side arm 16 and 18 toward the opened configuration, with or without pushing against the side arm tongue 132.

Although the present invention has been described hereinabove by way of preferred embodiments thereof, it can be modified, without departing from the spirit and nature of the subject invention as defined in the appended claim.

What is claimed is:

1. A lens and eyeglasses component assembly, said lens and eyeglasses component assembly comprising:
a lens, said lens defining a lens first surface, a substantially opposed lens second surface and a lens peripheral surface extending therebetween, said lens also defining a lens aperture extending between said lens first and second surfaces, said lens aperture being located adjacent said lens peripheral surface and defining a lens gap in said lens peripheral surface leading thereinto, said lens aperture defining a lens aperture peripheral surface;
an eyeglasses component, said eyeglasses component defining a lens attachment portion inserted in said lens aperture; and
a locking component inserted in said lens aperture, said locking component frictionally engaging both said lens aperture peripheral surface and said lens attachment portion;
whereby said locking component attaches said eyeglasses component to said lens.
